(19) United States
(12) Patent Application Publication
(10) Pub. No.: US 2016/0080439 A1
(43) Pub. Date: Mar. 17, 2016

(54) Media Sharing Device

(71) Applicant: Lineage Labs, Inc., Westford, MA (US)

(72) Inventors: Firdaus Bhathena, Andover, MA (US); Jeffrey Anuszczyk, Framingham, MA (US); Rakesh Godhani, North Andover, MA (US); David Chamberlain, New Boston, NH (US); Nancy Dussault Smith, South Weymouth, MA (US)

(73) Assignee: Lineage Labs, Inc., Westford, MA (US)

(21) Appl. No.: 14/847,562

(22) Filed: Sep. 8, 2015

Related U.S. Application Data
(60) Provisional application No. 62/049,698, filed on Sep. 12, 2014.

(51) Int. Cl. H04L 29/06; G06T 3/00; G06F 3/0484; G06T 1/00; H04L 29/08; G06F 3/0488

(52) U.S. Cl. CPC H04L 65/403; H04L 67/306; G06F 3/0488; G06F 3/04845; G06T 1/0007; G06T 3/0006; H04L 67/025

(57) ABSTRACT

A method includes receiving, at a local computing device, an indication of connection of a remote user device to a communication network of the local computing device, and establishing communication between the local computing device and the remote user device. The method also includes: accessing, using the local computing device, image data on remote non-transitory memory of the remote user device; and identifying, using the local computing device, any image data on the remote non-transitory memory not previously stored on local non-transitory memory in communication with the local computing device. The method also includes storing the identified image data on the local non-transitory memory.

### CROSS REFERENCE TO RELATED APPLICATIONS

This U.S. patent application claims priority under 35 U.S.C. §119(e) to U.S. Provisional Application 62/049,698, filed on Sep. 12, 2014, which is hereby incorporated by reference in its entirety.

### TECHNICAL FIELD

This disclosure relates to media storage and sharing media between multiple users of multiple devices.

### BACKGROUND

Social media allows people to create, share, or exchange information and ideas in virtual communities or networks. Social media depends on mobile and web-based technologies to allow people to share, co-create, collaborate on, discuss, and modify user-generated content. One aspect of social media is photo sharing, which allows a user to transfer his/her personal digital photos online and share the photos with others, privately or publicly.

In recent years, use of computers, smartphones, and other Internet-connected devices has grown exponentially. Correspondingly, most of these devices include a camera that is capable of capturing photographs and videos (including audio). These camera phones are usually less complicated than a traditional camera (e.g., a digital camera); however, camera phones have greatly improved the quality of the pictures. Therefore, it is easy for a person to take a picture using a camera phone and share it with the world within a matter of seconds. As they say “a picture is worth a thousand words,” and photo sharing has become an important aspect of sharing information over social media.

### SUMMARY

One aspect of the disclosure provides a method that includes receiving, at a local computing device (e.g., a photo-sharing device), an indication of a connection of a remote user device to a communication network of the local computing device, establishing communication between the local computing device and the remote user device, and accessing image data on remote non-transitory memory of the remote user device using the local computing device. The method also includes identifying, using the local computing device, any image data on the remote non-transitory memory not previously stored on local non-transitory memory in communication with the local computing device and storing the identified image data on the local non-transitory memory.

Implementations of the disclosure may include one or more of the following features. In some implementations, the image data includes photo image data and/or video image data.

In some examples, the method further includes determining, using the local computing device, an available storage capacity of the remote non-transitory memory. When the available storage capacity is less than a threshold available storage capacity, the method includes identifying image data on the remote non-transitory memory currently stored on the local non-transitory memory and deleting at least some of the image data on the remote non-transitory memory currently stored on the local non-transitory memory to provide at least the threshold available storage capacity on the remote non-transitory memory. The method may further include identifying for deletion from the remote non-transitory memory, using the local computing device, infrequently accessed image data currently stored on the local non-transitory memory. Additionally or alternatively, the method may include identifying for deletion from the remote non-transitory memory, using the local computing device, image data currently stored on the local non-transitory memory and having image metadata matching metadata criteria.

In some implementation, the method further includes, using the local computing device, identifying whether a user profile is associated with the user device. When a user profile is associated with the user device, the method also includes storing the identified image data on the local non-transitory memory according to storage criteria of the user profile. The storage criteria may disallow storage of identified image data on the local non-transitory memory when the identified image data has associated image metadata matching disallow criteria of the storage criteria. Additionally or alternatively, the storage criteria may allow storage of identified image data on the local non-transitory memory when the identified image data has associated image metadata matching allow criteria of the storage criteria.

In some implementations, the method further includes storing, using the local computing device, the identified image data on the local non-transitory memory according to default storage criteria when a user profile is not associated with the user device. The method may further include displaying, using the local computing device, image data stored on the local non-transitory memory on a display screen (e.g., a television screen) in communication with the local computing device. In some examples, the method also includes receiving, at the local computing device, a gesture command, the gesture command received on a touch screen of the user device and indicating whether to display selected image data stored on the local non-transitory memory on the display screen.

The method may further include receiving, at the local computing device, an image data manipulation from the remote user device for the identified image data. In some examples, the image data manipulation includes at least one of an image crop, an image rotation, an image alteration, or an image resize. In some examples, the method also includes receiving, at the local computing device, an image metadata manipulation from the remote user device for the identified image data.

Another aspect of the disclosure provides a storage device that includes a body, a local computing device housed by the body, and local non-transitory memory. The local non-transitory memory is in communication with the computing device and is housed by the body. The local non-transitory memory stores instructions that when executed by the local computing device cause the local computing device to perform operations. The operations include receiving, at the local computing device, an indication of connection of a remote user device to a communication network of the local computing device, establishing communication between the local computing device and the remote user device and accessing, using the local computing device, image data on remote non-transitory memory of the remote user device. The operations also include identifying, using the local computing device, any image data on the remote non-transitory memory not previously stored on local non-transitory memory in communication with the local computing device and storing the identified image data on the local non-transitory memory.

In some examples, the operations further include determining, using the local computing device, an available storage capacity of the remote non-transitory memory. When the available storage capacity is less than a threshold available storage capacity, the operations include identifying image data on the remote non-transitory memory currently stored on the local non-transitory memory and deleting at least some of the image data on the remote non-transitory memory currently stored on the local non-transitory memory to provide at least the threshold available storage capacity on the remote non-transitory memory.

The operations may further include identifying for deletion from the remote non-transitory memory, using the local computing device, infrequently accessed image data currently stored on the local non-transitory memory. In some examples, the operations include identifying for deletion from the remote non-transitory memory, using the local computing device, image data currently stored on the local non-transitory memory and having image metadata matching metadata criteria.

In some implementations, the operations further include identifying whether a user profile is associated with the user device and when a user profile is associated with the user device, storing the identified image data on the local non-transitory memory according to storage criteria of the user profile. In some examples, the storage criteria disallows storage of identified image data on the local non-transitory memory when the identified image data has associated image metadata matching disallow criteria of the storage criteria. Additionally or alternatively, the storage criteria may allow storage of identified image data on the local non-transitory memory when the identified image data has associated image metadata matching allow criteria of the storage criteria.

The operations may further include storing, using the local computing device, the identified image data on the local non-transitory memory according to default storage criteria when a user profile is not associated with the user device. In some examples, the operations may further include displaying, using the local computing device, image data stored on the local non-transitory memory on a display screen in communication with the local computing device. The operations may further include receiving, at the local computing device, a gesture command, the gesture command received on a touch screen of the user device and indicating whether to display selected image data stored on the local non-transitory memory on the display screen.

In some implementations, the storage device receives at the local computing device an image data manipulation from the remote user device for the identified image data. The image data manipulation includes at least one of an image crop, an image rotation, an image alteration, or an image resize.

The storage device may receive, at the local computing device, an image metadata manipulation from the remote user device for the identified image data. The image data may include photo image data and/or video image data. In some examples, the storage device includes a media card receiver supported by the body and in communication with the computing device.

In some implementations, the storage device includes a visual indicator (e.g., an LED) supported by the body and in communication with the computing device. The visual indicator indicating storage of the identified image data on the local non-transitory memory. The storage device may include an audio device supported by the body and in communication with the computing device. The audio device emitting a human perceptible sound indicating storage of the identified image data on the local non-transitory memory. The storage device may include a media electrical connector (e.g., HDMI connector) supported by the body and in communication with the computing device. Additionally or alternatively, the storage device may include a wireless transceiver supported by the body and in communication with the computing device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary photo-sharing system allowing one or more users to share photos and videos over one or more networks.

FIG. 1B is a schematic view of the exemplary photo-sharing system allowing one or more users to share photos and videos over a home network.

FIG. 2A is a schematic view of an exemplary user device in communication with a photo-sharing device.

FIG. 2B is a schematic view of an exemplary method of detecting a user device on a home network.

FIG. 2C is a schematic view of exemplary user devices capable of taking photos and videos and having a photo-sharing application.

FIG. 2D is a schematic view of an exemplary printed circuit board of a photo-sharing device.

FIG. 3 is a schematic view of an exemplary home, where each member of the home shares their photos using the photo-sharing system.

FIG. 4 is a schematic view of an exemplary view of a photo-sharing application.

FIG. 5 is a schematic view of an exemplary photo-sharing device.

FIG. 6 is a schematic view of an exemplary arrangement of operations for communication between devices within the network in an exemplary photo-sharing system.

Like reference symbols in the various drawings indicate like elements.

### DETAILED DESCRIPTION

A photo sharing system of the present discloser implements photo sharing based on photos and videos received from one or more user devices. The photo sharing system receives one or more photo(s) and/or video(s), organizes the photo(s) and/or video(s), allows the user to share the photo(s) and/or video(s), protects the received photo(s) and/or video(s) (for example, by backing up the photo(s) and/or video(s) into a secondary non-transitory memory), and finally allows the user(s) to view the photo(s) and/or video(s) received from the one or more users. Therefore, a group of people living in the same household (e.g., a family of five), where each member of the group has one or more device(s), can share their photo(s) and/video(s) using the photo-sharing system. The photo sharing system allows multiple photo takers in one household to seamlessly share photos between the members of the household. In addition, the photo sharing system provides an in-home photo sharing device that stores photos from all the members of the household in one location.

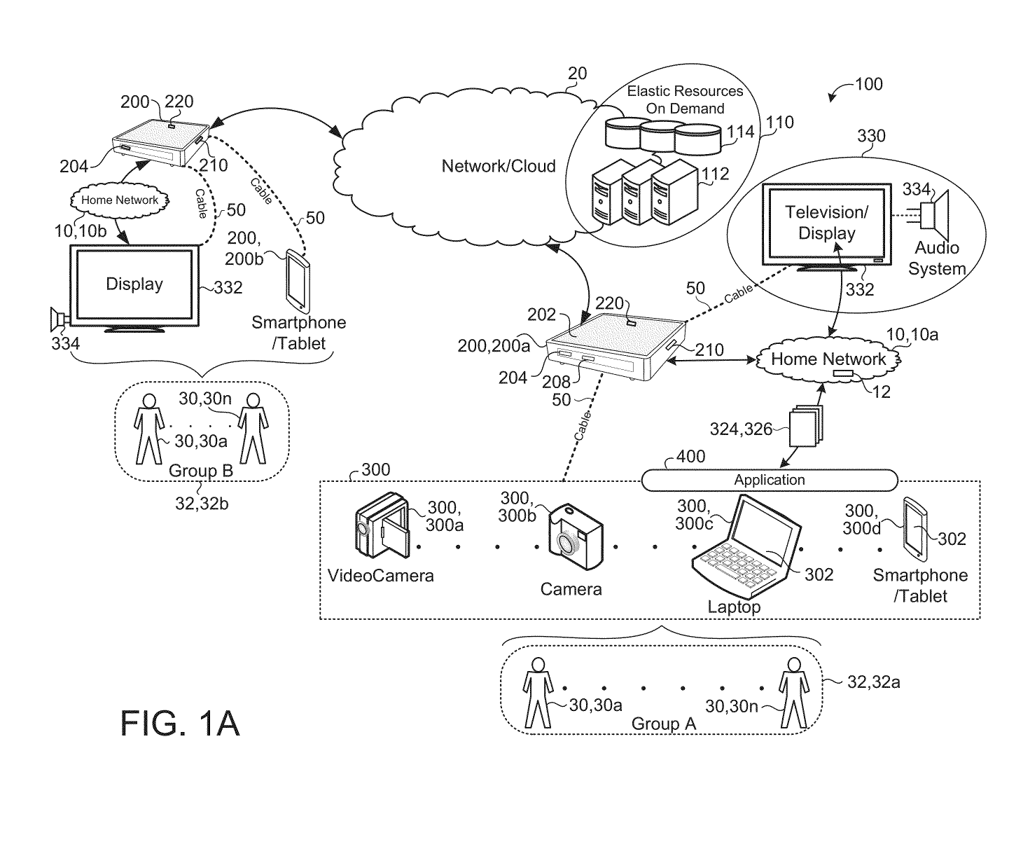

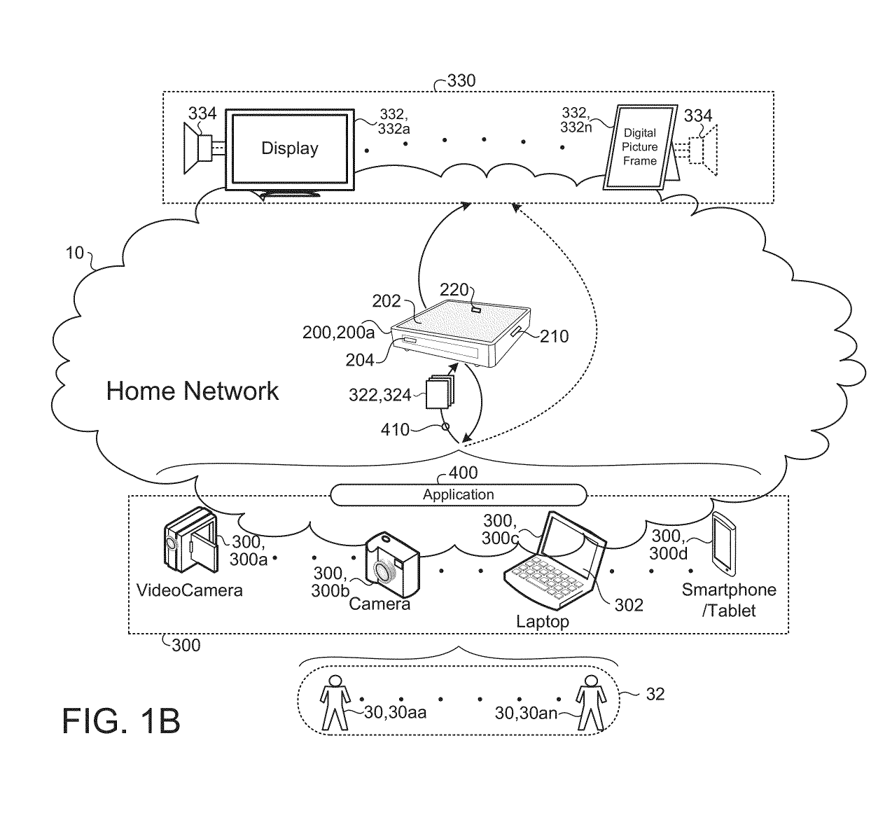

Referring to FIGS. 1A-B, in some examples, the system 100 includes a photo-sharing device 200 capable of communicating with one or more user devices 300 (e.g., computer, portable electronic device, smartphone, tablet PC, cellular telephone, portable digital assistant, digital camera, digital video camera) associated with one or more users 30, one or more photo-sharing display system 330 (e.g., a display 332 in communication with an audio system 334 for outputting audio recordings), and/or one or more networks 10, 20. In some examples, the user device 300 executes a photo-sharing application 400 that allows each user device 300 to upload/download photos 322 and/or videos 324 (or other digital content) to the photo-sharing device 200. In other examples, a user 30 connects the user device 300 to the photo-sharing device 200 using a cable 50. The photo-sharing display system 100 may include one or more of a television display 332a, a digital photo frame 332n, or any other display 332 connected or not connected to an audio system 334.

In some implementations, a home network 10 provides communication between the photo-sharing device 200 and user devices 300 associated with users 30. The home network 10 may be a local area network (LAN) that allows smart devices and computers (such as the photo-sharing device 200, the user devices 300, or the display 330) to interconnect within a limited area (e.g., a home, a school, an office building). In some examples, the home network 10 is a home area network (HAN), which is a type of LAN facilitating communication and interoperability among smart devices located near or inside a home. Some of the technologies used for building LANs include, but are not limited to, ARCNET®, Token Ring, Ethernet (over twisted cables), and Wi-Fi (wireless).

The home network 10 may include one or more of a physical layer, a data link layer, and network layer connectivity, both internally between the devices and externally with a shared network 20. The home network 10 generally includes a modem, a router 12, the network switch, a wireless access point, and optionally network bridge. In some examples, an Internet service provider (ISP) provides a modem to a user 30, which allows the user 30 to connect user devices 300 to a shared network 20 (e.g., Wide Area Network (WAN)). In some examples, the user devices 300 are connected to the modem using an Ethernet interface. The router 12 manages network layer connectivity between the home network 10 and the shared network 20. In some examples, a network switch is used and allows devices 300 on the home network 10 to communicate with one another via is Ethernet. In some examples, the home network 10 does not include a network switch, and instead the router 12 includes a built-in switching capacity or the network includes Wi-Fi allowing for wireless connection between the devices 300. The home network 10 includes a wireless access point that connects the wireless devices to a shared network 20. In some examples, the wireless access point in integrated in the router 12. In some examples, a network bridge connects two network interfaces with one another. A network bridge is used to connect a wired device to a wireless network, allowing the device to communicate with other devices over the home network 10. The home network 10 may include a broadband modem, which is residential gateways that integrate the functions of a modem, network address translation (NAT) router, Ethernet switch, Wi-Fi access point, dynamic host configuration protocol (DHCP) server, and firewall, among others.

A user 30 may connect a user device 300 to the photo-sharing device 200 via a cable 50. The cable 50 may be any type of cable that supports uploading/downloading of photos 322 and/or videos 324 (or other digital content), or any type of cable that allows displaying on a display 332 pictures and video 324 (or other digital content), and outputting audio associated with the pictures and video 324 through an audio system 334. The cable 50 may include, but is not limited to, an HDMI (High-Definition Multimedia Interface) cable, USB (Universal Serial Bus), RCA (used between the photo-sharing device 200 and the display 332), or any other connectors. Moreover, the photo-sharing device 200 connects via a cable 50 (e.g., HDMI) to a display 332 (e.g., a television) in communication with an audio system 334 for outputting audio recording.

In some implementations, a first home network 10a communicates with a second home network via a shared network 20. The shared network 20 may be a wide area network (WAN) that covers a broad area and uses leased or private telecommunication lines. For example, the shared network 20 links networks across metropolitan, regional, national, or international boundaries. Therefore, the first and second home networks 10a, 10b may be in a different city, in a different state, on a different continent, or separated by an ocean and the shared network 20 is able to allow communication between the two home networks 10a, 10b.

The shared network 20 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The shared network 20 may include one or more of a Wide Area Network (WAN), a Local Area Network (LAN), and a Personal Area Network (PAN). In some examples, the shared network 20 includes a combination of data networks, telecommunication networks, and a combination of data and telecommunication networks. Additionally or alternatively, the shared network 20 provides access to cloud computing resources 110, which may be elastic/on-demand computing and/or storage resources available over the shared network 20. The term ‘cloud’ services generally refers to a service performed not locally on a user's device, but rather delivered from one or more remote devices accessible via one or more networks 20. The cloud computing resources 110 may be a distributed system (e.g., cloud environment) having scalable/elastic computing resources 114 and/or storage resources 114. In some examples, the photo-sharing device 200 receives photos 322 and/or videos 324 (or other digital content) from the user device 300 and stores the received photos 322 and/or videos 324 (or other digital content) in the non-transitory memory 220 of the photo-sharing device 200. Additionally, the photo-sharing device 200 may transmit a copy of the received photos 322 and/or videos 324 to the storage resources 114 of the cloud to create a copy of the photos, allowing a user 30 to retrieve the photos and/or videos if a user 30 accidentally deletes some or all the photos 322 and/or videos 324 from the memory 220 of the photo-sharing device 200.

The photo-sharing device 200 is a network device, i.e., it is a device capable of connecting one or more home networks 10 with the shared network 20. The photo-sharing device 200 includes a housing 202 (e.g., a body) constructed by one or more portions, for example, the housing 202 may include a top, bottom, front, back, right, and left portions. The housing 202 protects components, such as electrical components, housed by the photo-sharing device 200. In some examples, the housing 202 includes a power a power supply (not shown) that provides power to the photo-sharing device 200. Moreover, the photo-sharing device 200 includes one or more input/output ports such as, but not limited to, HDMI, USB, Bluetooth, Ethernet, wireless Ethernet, where any one of the ports may be used to communicate with a user device 300 or a display system 330. Moreover, the photo-sharing device 200 may include one or more media card receivers (e.g., microSD card slot and/or SD(HX/XC) card slot) supported by the housing 202 and in communication with the photo-sharing device 200. The media card receiver is configured to receive a media card for storing photos 322 and/or videos 324 from the photo-sharing device 200 to the media card or vice versa. Additionally, the photo-sharing device 200 may include an audio device 208 supported by the housing 202. The audio device 208 emits a human perceptible sound indicating storage of the identified photo 322 and/or video 324 on the non-transitory memory 220 of the photo-sharing device 200.

The photo-sharing device 200 includes a processor 210 (e.g., a local computing device or local data processing hardware) in communication with non-transitory memory 220 (e.g., memory hardware). The non-transitory memory 220 may be physical devices used to store programs (e.g., sequences of instructions) or data (e.g., program state information) on a temporary or permanent basis for use by a computing device 210. The non-transitory memory 220 may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The non-transitory memory 220 (e.g., a hard drive (HDD)) of the photo-sharing device 200 stores photos 322 and videos 324 and retains the stored photos 322 and videos 324 when the photo-sharing device 200 is not powered. In some examples, the non-transitory memory 220 has a size of 500 gigabytes or one or more Terabyte.

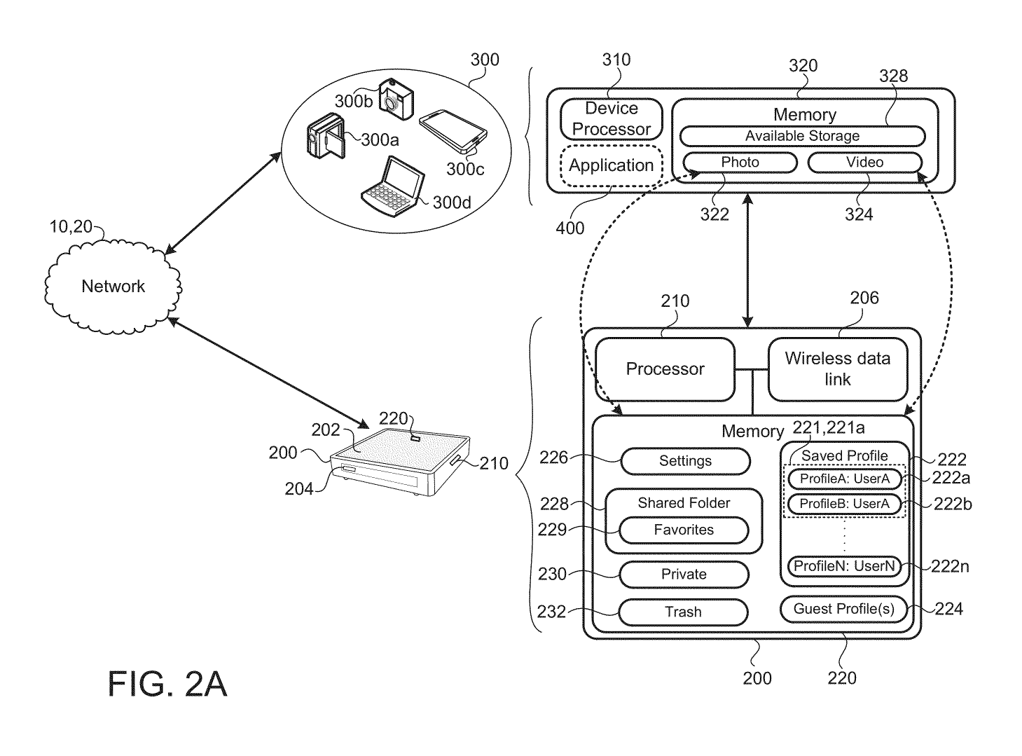

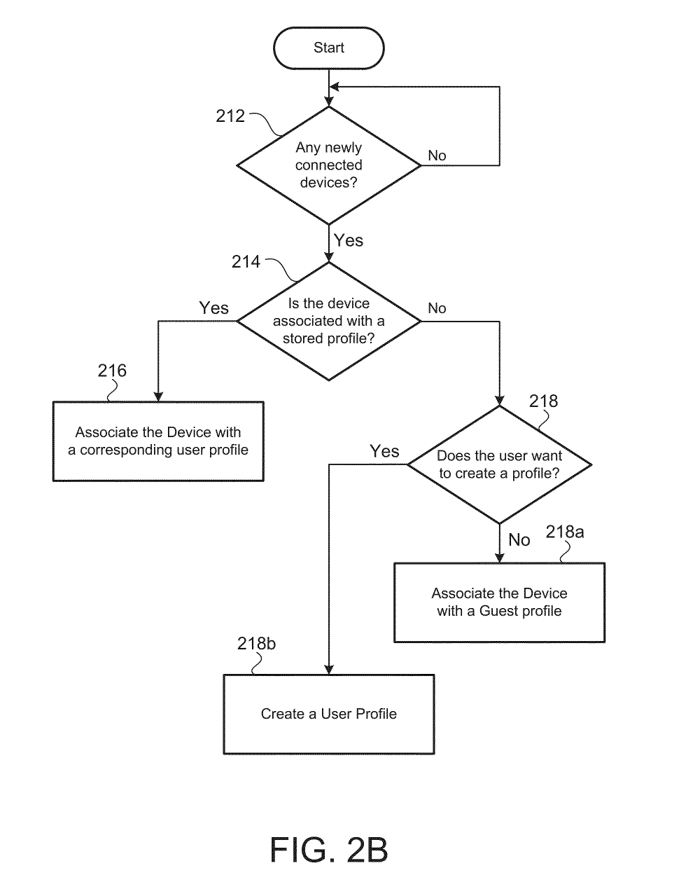

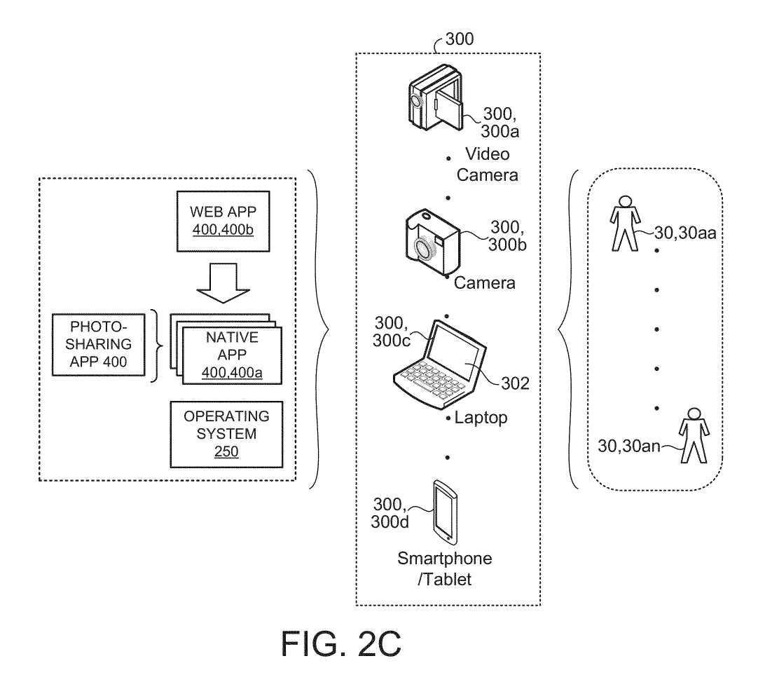

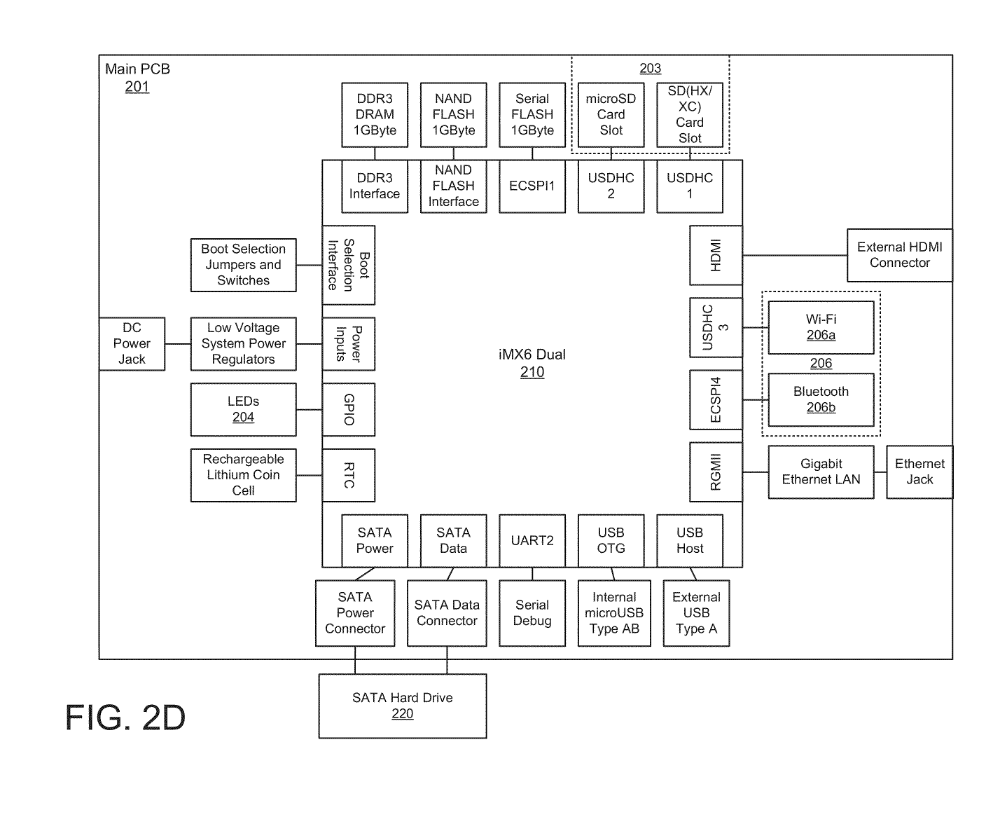

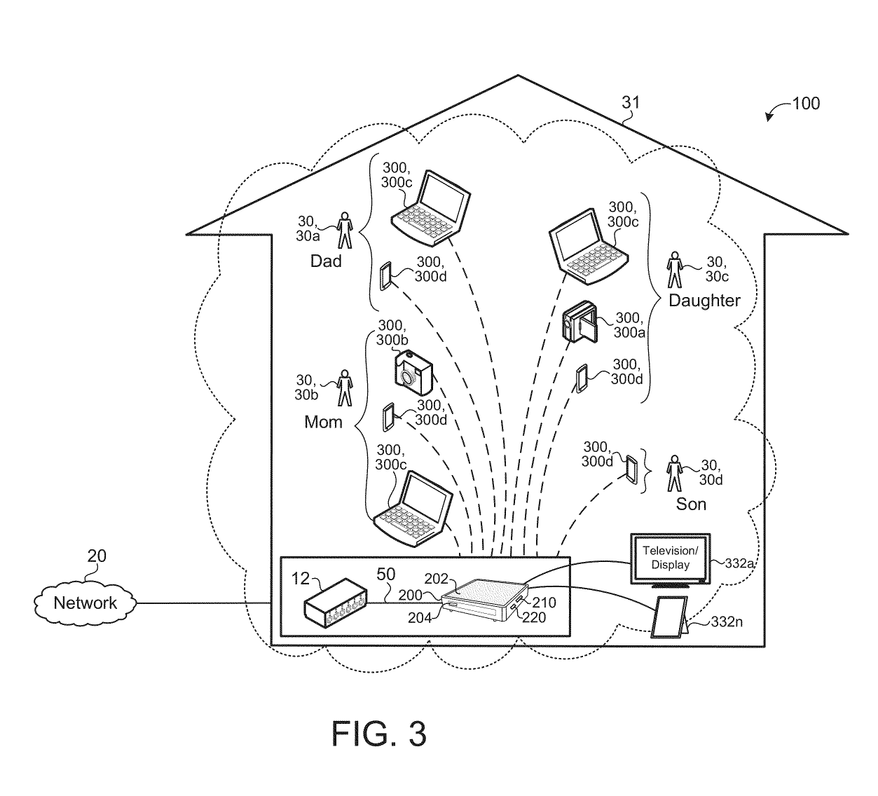

Referring to FIG. 2A-3, in some implementations, the photo-sharing device 200 includes a wireless data link 206 that allows for communication between the network 20 and the user devices 300 and/or between multiple user devices 300 of the household or group 32 (allowing the users 30 to share pictures/videos). The wireless data link 206 communicates with the processor 210 of the photo-sharing device 200. In some examples, the photo-sharing device 200 (e.g., the processor 210) continually queries the home network 10 (e.g., the router 12) to detect a user device 300 connected or has recently connected to the home network 10.

FIG. 2B is a schematic view of an exemplary method of detecting a user device located near the photo-sharing device 200. The processor 210 determines, at block 212, if any user devices 300 are connected to the home network 10, or are within a threshold distance of the photo-sharing device 200 (e.g., using Bluetooth, near field communication (NFC), or any other method). If the processor 210 fails to detect any newly connected device 300, the processor 210 keeps checking for any newly connected devices 300. When the processor 210 determines that a user device 300 is connected to the home network 10 or is within the threshold distance of the photo-sharing device 200, then the processor 210, at block 214, determines if the detected user device 300 is associated with a stored profile 222 of a previously detected user device 300. If the processor 210 determines that the newly connected user device 300 was previously connected to the photo-sharing device 200 and the photo-sharing device 200 created a user device profile 222 for the user device 300, then the processor 210 associates the previously created user device profile with the detected user device 300, at block 216. If, however, the processor 210 determines that the newly connected user device 300 has not been previously connected to the photo-sharing device 200, then the processor 210 asks the user 30, at 218, (via a photo-sharing application 400 configured to allow for interaction between the photo-sharing device 200 and the user 30 via the user display 302 of the user device 300) if the user 30 wants to create a user device profile 222 associated with the user device 300. If the user 30 does not want to create a user device profile 222, then the processor 210, at 218a, associates a guest device profile 224 with the connected user device 300. If the user 30 wants to create a user device profile 222, then the processor 210, at 218b, creates a user device profile 222 associate with connected user device 300. In some examples, multiple user device profiles 222, 222a-n and multiple guest device profiles 224 are stored in non-transitory memory 220 of the photo-sharing device 200.

In some implementations, the processor 210 recognizes a user device 300 that joined the home network 10 or within the threshold distance of the photo-sharing device 200 and associates a user device profile 222 (previously created) with the user device 300. The photo-sharing device 200 may include one or more user adjustable settings 226. The user adjustable settings 226 can be adjusted by a user 30 (via a photo-sharing application 400 configured to allow for interaction between the photo-sharing device 200 and the user 30 via the user display 302 of the user device 300) and stored in non-transitory memory 220. The user adjustable settings 226 may include settings such as frequency of upload/retrieval, automatic upload/retrieval on/off, upload location (private or shared), and when any other user device profile 222 may view the photos 322 and/or videos 324 stored in a private folder 230 or device folder associated with a user device 300. A user 30 may organize his/her folders on the user device(s) 300 and indicate specific folders on the user device(s) 300 for uploading.

The photo-sharing device 200 may include a trash folder 232 for storing any deleted pictures from the shared folder 228. The trash folder 232 provides an additional security layer to any authorized users 30 to delete photos 322 and/or videos 324 from the photo-sharing device 200. Therefore, any deleted photos 322 and/or videos 324 are stored in the trash folder 232 and only deleted from the trash folder 232 when a user 30 provides an authorization (e.g., a numeric pin or an alphanumeric password) to view and empty the trash folder 232.

In some implementations, the user device profile 222 includes a main user device profile 222a associated with a user 30 or any specific user device 300 associated with a user 30. The main user device profile to 222a controls permissions and settings 226 of the other profiles 222, 224. For example, the main user device profile 222a determines the user device profiles 222 and guest device profiles 224 associated with a user 30 that are allowed to delete photos 322 and/or videos 324 from the shared folder 228. In some instances, the user 30 associated with the main user device profile 222a determines which user device profiles 222 or a guest device profile 224 can edit or mark a photo 322 and/or a video 324 as a favorite 229. Moreover, the main user device profile 222a may determine whether a user device profile 222 or a guest device profile 224 are allowed to upload pictures from the memory 220 of the photo-sharing device 200 to a user device 300 associated with the profile 222, 224. In some examples, the main profile 222a selects specific settings for each user device profile 222 or guest device profile 224, while in other examples, the main user device profile 222a selects settings that are applicable to all the users 30 or user devices 300.

The processor 210 may maintain the source of the photos 322 and/or videos 324, i.e., from which user device 300 the photo-sharing device 200 retrieved the photos 322 and/or videos 324. The user 30 may reorganize the photos 322 and/or videos 324 and place the photos 322 and/or videos 324 in different shared folders 228, or may adjust the photos 322 and/or videos 324 based on tags, labels, collections, albums, or any other organizing method.

In some examples, the main user 222a sets a password or pin that protects some features of the photo-sharing device 200. For examples, if a family of four share their photos and/or videos using the photo-sharing device 200, the parents may be associated with the main profile 222a (i.e., more than one main user device profile may be available) and the children may be associated with user device profiles 222 (not being the main profile). The family member associated with the main user 30 selects the level of access the children in the family are allowed. The user 30 associated with main user device profile 222a may determine that the profile associated with the children is only allowed to upload photos 322 and videos 324 to the photo-sharing device 200; however, the main user 30a may determine that the children are not allowed to download photos 322 and videos 324 to their user devices 300 from the photo-sharing device 200. In some examples, a user 30 who has a device 300 that is associated with a guest device profile 224 and connected to the home network 10 or is within the threshold distance of the photo-sharing device 200 may enter the password or pin to change his/her profile from the guest device profile 224 to a user device profile 222. Once the guest user 30 is associated with the user device profile 222, the guest user 30 may access the photo-sharing device 200 when the user device 300 is not within the home network 10 or within a threshold distance of the photo-sharing device 200. In addition, the main user device profile 222a may remove or take away the user device profile 222 associated with the guest user 30. In such a case, the device 300 of the guest user 30 reverts back to being associated with a guest device profile 224.

The non-transitory memory 220 may include a favorite folder 229 associated with each user device 300. Therefore, the photo-sharing device 200 may keep track of the photos 322 and/or videos 324 marked as favorite by each user 30. In some examples, the processor 210 displays an indicator (e.g., a star) on the display 302, 332 when a photo 322 and/or a video 324 is marked as a favorite. In some examples, a different indicator is associated with different users 30, therefore, two users 30 marked the same photo 322 and/or a video 324 as a favorite, then the processor display on the display 302, 332 two indicators (e.g., two stars each being a different color). Thus a user 30 can view photos 322 and/or videos 324 based on the number of users 30 who marked the photo 322 and/or a video 324 as a favorite.

Referring to FIG. 2D, in some implementations, the photo-sharing device 200 includes a main processor board 201 that includes Freescale iMX6 dual core Cortex A9 processor 210 which can run Linux and can provide an HDMI video output to the display 332. The iMX range is a family of Freescale Semiconductor™ proprietary microprocessors ARM® architecture which focuses on low-power consumption. The processor 210 may include one gigabyte of NAND Flash for operating system/application storage and one gigabyte of DDR3 SDRAM (Double Data Rate Type Three Synchronous dynamic random access memory). In some examples, the processor 210 includes an interface to a SATA (Serial ATA) hard drive for local storage of media files. Additionally, the photo-sharing device 200 may include an external SD (secure digital) card slot 203 for downloading files, such as photos and videos. Moreover, the photo-sharing device 200 may include an internal microSD card slot 203 for boot image loading. A boot image is a type of disk image (i.e., a computer file containing complete contents and structure of a computer storage media). The processor 210 may include an 802.11b/g/n Wi-Fi radio chip 206a that provides connectivity to a home network 10 and an external Gigabit Ethernet connection that allows access to a wired network. In some examples, the photo-sharing device 200 also includes a Bluetooth Low Energy radio 206b for connection to a user device 300. The Bluetooth connection 206b allows the user device 300 to establish a connection with the photo-sharing device 200 and transfer photos and/or videos to and from the photo-sharing device 200. In some examples, the photo-sharing device 200 includes internal connectors for serial debug and USB OTG (Universal Serial Bus On-The-Go) for BSP and application loading and debugging purposes. A two megabyte serial Flash is provided for storage of configuration information.

In some examples, the photo-sharing device 200 includes one or more indicators 204 that are visible to users 30. The indicators 204 provide an indication of a status of the photo-sharing device 200. The indicators may be LED indicators, or may include a display that displays the status of the photo-sharing device 200. For example, a different indicator 204 may be shown when the photo-sharing device 200 is searching for a user device 300 or when the photo-sharing device 200 is uploading or downloading photos 322 and/or videos 324 to or from a user device 300 or another photo-sharing device 200 locations within a different home network 10 than the current photo-sharing device 200.

In some examples, the photo-sharing device 200 receives photos 322 and/or videos 324 from a user device 300 or from another photo-sharing device 200, where each photo-sharing device 200 is part of a different home network 10. For example, referring to FIG. 1A, the first photo-sharing device 200a may send photos 322 and/or videos 324 to a second photo-sharing device 200b, or vice versa. Each photo-sharing device 200a, 200b being in a different home network 10a, 10b, where the home networks 10a, 10b communicate via the shared network 20. The second photo-sharing device 200b receives the photos 322 and/or videos 324 from the first photo-sharing device 200a and stores the received photos 322 and/or videos 324 in a shared folder 228 of the memory 220 of the second photo-sharing device 200b. Similarly, if the second photo-sharing device 200b is sending or sharing photos 322 and/or videos 324 with the first photo-sharing device 200a, then the first photo-sharing device 200a receives the photos 322 and/or videos 324 from the second photo-sharing device 200b and stores the received photos 322 and/or videos 324 in a shared folder 228 of the memory 220 of the first photo-sharing device 200.

Referring to FIGS. 1A-2C, in some implementations, the user device 300 is associated with a user 30 and is in communication with a remote system 110 via a network 20. The cloud computing resources 110 may be a distributed system (e.g., cloud environment) having scalable/elastic computing resources 114 and/or storage resources 114. The user device 300 and/or the remote system 110 may execute a photo-sharing application 400 and optionally receive photos 322 and videos 324 from one or more photo-sharing devices 200 or user devices 300.

The user device(s) 300 may be any computing device capable of capturing or storing photos 322 and/or videos 324 and transferring or uploading the photos 322 and/or videos 324 to the photo-sharing device 200. User devices 300 include, but are not limited to, mobile computing devices, such as video cameras 300a, photo cameras 300b, laptops 300c, smart phones or tablets 300d, wearable computing devices (e.g., headsets and/or watches). User devices 300 may also include other computing devices having other form factors, such as computing devices included in desktop computers, vehicles, gaming devices, televisions, or other appliances (e.g., networked home automation devices and home appliances).

The user devices 300 may use a variety of different operating systems 250. In examples where a user device 300 is a mobile device, the user device 300 may run an operating system including, but not limited to, ANDROID® developed by Google Inc., IOS® developed by Apple Inc., or WINDOWS PHONE® developed by Microsoft Corporation. Accordingly, the operating system 250 running on the user device 300 may include, but is not limited to, one of ANDROID®, IOS®, or WINDOWS PHONE®. In an example where a user device 300 is a laptop or desktop computing device 300c, the user device 300 may run an operating system including, but not limited to, MICROSOFT WINDOWS® by Microsoft Corporation, MAC OS® by Apple, Inc., or Linux. User devices 300 may also access the photo-sharing application 400 while running operating systems 250 other than those operating systems 250 described above, whether presently available or developed in the future.

Referring to FIGS. 2A and 3, in some implementations, first, second, third, and fourth users 30a, 30b, 30c, 30d of a first group 32a (e.g., the Jones family) live in a house 31, while other users 30n are of a second group 32b (FIG. 1A), which may live elsewhere. The first user 30a (e.g., dad) has a laptop 300c and a smartphone 300d; the second user 30b (e.g., mom) has a digital camera 300b, a smartphone/tablet 300d, and a laptop 300c; the third user 30c (e.g., daughter) has a laptop 300c, a digital video camera 300a, and a smartphone/tablet 300d; and the fourth user 30d (e.g., son) has a smartphone 300d. In some examples, each individual user 30a, 30b, 30c, 30d uses his/her personal user device 300 to take photos 322 and/or videos 324. The family 32 may want to share all the photos 322 and/or videos 324 from the multiple devices 300 of each user 30a, 30b, 30c. 30d within the family 32, and view the photos 322 and/or videos 324 collectively as a family 32. The photo-sharing device 200 retrieves photos 322 and/or videos 324 from the multiple user devices 300 and stores the retrieved photos 322 and/or videos 324 in the non-transitory memory 220 of the photo-sharing device 200. As previously explained, the photo-sharing device 200 may connect wirelessly or using a cable 50 to the user devices 300. In some examples, the user 30 may set up his/her user device(s) 300 to automatically download or allow the photo-sharing device 200 to automatically retrieve the photos 322 and/or videos 324 to/from the user device 300. Once the photos 322 and/or videos 324 are downloaded/retrieved from the one or more user devices 300, the photo-sharing device 200 stores the photos 322 and/or videos 324 in its non-transitory memory 220, which allows any or all family members 30 to access and manipulate the photos 322 or the videos 324.

In some examples, when the user device 300 is not within the home network 10 or within a threshold distance of the photo-sharing device 200 of the photo-sharing device 200, the user 30 may upload the photos 322 and/or videos 324 to the photo-sharing device 200 via the shared network 20. As previously discussed, in some examples, only users 30 associated with a user device profile 222 (as opposed to a guest device profile 224) have access to the photo-sharing device 200 when the user device 300 is not within the home network 10 or within a threshold distance of the photo-sharing device 200 of the photo-sharing device 200. Other access arrangements are possible as well. Moreover, in some instances, the user 30 may be prompted (via a photo-sharing application 400 configures to allow for interaction between the photo-sharing device 200 and the user 30 via the user display 302 of the user device 300) to determine whether to allow the photo-sharing device 200 to access the non-transitory memory 320 of the user device 300 and delete or keep the photo 322 and/or a video 324 after they are uploaded to the non-transitory memory 220 of the photo-sharing device 200.

Referring to FIGS. 2A and 3, in some examples, a user 30 may have one or more user devices 300. Therefore, the photo-sharing device 200 may associate a user device profile 222 with each user device 300 and associate a user profile 221 with the user 30 of the multiple user devices 300. For example, the photo-sharing device 200 associates three different device user profiles 222a, 222b, 222c with each of the dad's devices, and associates a user profile 221a with the dad 30a that links all the devices 222a, 222b, 222c to the dad profile 221a. Moreover, the dad 30a may have some personal photos/videos that he does not want to share with the family 32 or wants to select which members of the family 32 to share these photos 322 and/or videos 324 with. The photo-sharing device 200 allows the dad 30a to store the private photos in a private folder 230 of the memory 220, allowing only the dad 30a and any other person that the dad 30a gives permission to view the photos 322 and/or videos 324.

In some examples, the main user device profile 222a associated with a main user 30 (e.g., dad 30a or mom 30b) determines which user device profiles 222 (or guest device profiles 224) can delete, edit, upload or download photos 322 and/or videos 324. Additionally, when a user 30 deletes a photo 322 and/or a video 324, the photo-sharing device 200 moves the deleted photo 322 and/or a video 324 from the shared folder 228 to the trash folder 232 (which may need a pin or password to delete the photos 322 and/or videos 324).

The photo-sharing device 200 may be connected to a network box 12 (i.e., a router or a gateway router) through a wired connection 50 (e.g., cable), such as a coaxial interface, an RJ-45 interface, and/or a wireless interface, such as an RG-45 Ethernet interface for 802.11 Wi-Fi. A Wi-Fi connection may be slower than a wired connection; therefore, a user 30 may determine which devices 300 he/she wants to connect wirelessly verses the devices 300 he/she wants to connect via a wired connection (e.g., cable 50). Such determination depends on the desired speed that the user 30 wants the device 300 to communicate with other devices 300 or the networks 10, 20. In some examples, the network box 12 includes Ethernet ports for connecting the electronic devices 300 to the network box 12 using an Ethernet cable. The network box 12 may have a predetermined number of output ports (e.g., four output ports) that support a wired connection (e.g., cable 50). A user 30 may need more than four output ports to connect his/her devices 300 and may connect a network device 300 capable of expanding the network 10 (expanding the wired network 10).

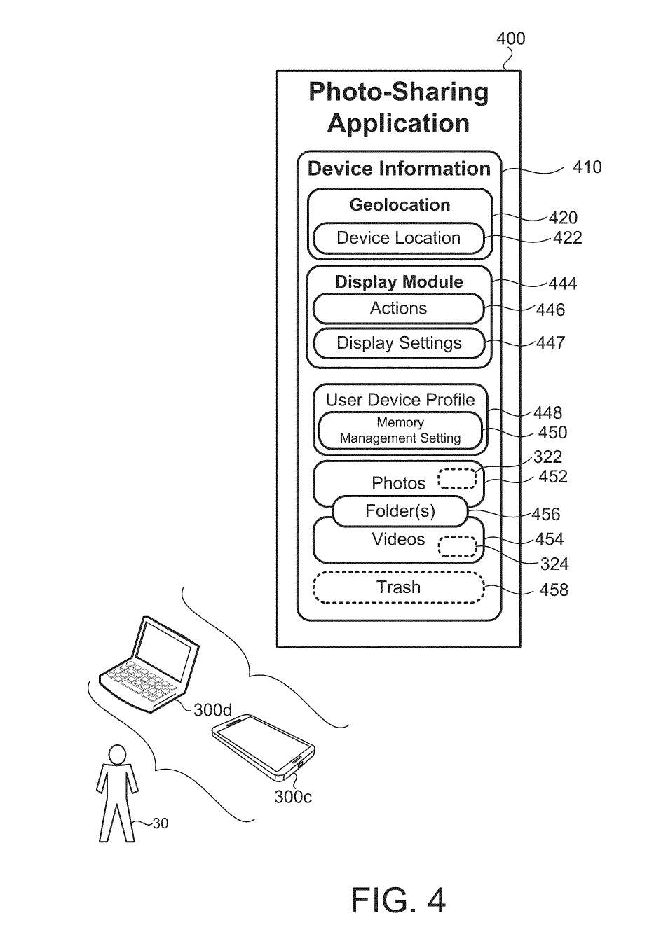

In some implementations, the user device 300 includes a device processor 310 in communication with a device non-transitory memory 320. The user device 300 is capable of transmitting photos 322 and/or videos 324 from the device non-transitory memory 320 to the memory 220 of the photo-sharing device. The device processor 310 executes a photo-sharing application 400 that allows the user 30 to download/upload and optionally edit photos 322 and/or videos 324 stored on the non-transitory memory 220 of the photo-sharing device 200. The photo-sharing application 400 retrieves device information 410 (See FIG. 4) from the user device 300 and transmits the information to the photo-sharing device 200. In some examples, the device non-transitory memory 320 includes a photo folder 452 (FIG. 4) for storing photos 322 and a videos folder 454 (FIG. 4) for storing video 324. The user 30 may add or rename folders to organize photos 322 and/or videos 324 in the device memory 320. Moreover, a user 30 may determine which folders to share with the photo-sharing device 200.

The photo-sharing application 400 allows the user 30 to download/upload photos and/or videos from or to the photo-sharing device 200 within a home network 10 that is connected to the user device 300 executing the photo-sharing application 400. In addition, the photo-sharing application 400 allows a user device 300 connected to a first home network 10a that is also connected to a first photo-sharing device 200a to connect to a second photo-sharing device 200b connected to a second home network 10b, where the first home network 10a and the second home network are connected via a shared network 20.

Referring back to FIG. 2C, a software application 400 may refer to computer software that, when executed by a computing device, causes the computing device to perform a task. In some examples, a software application 400 may be referred to as an “application”, an “app”, or a “program”. Example software applications 400 include, but are not limited to, word processing applications, spreadsheet applications, messaging applications, media streaming applications, social networking applications, and games.

Applications 400 can be executed on a variety of different user devices 300. In some examples, a native application 400a may be installed on a user device 300 prior to a user 30 purchasing the user device 300. In other examples, the user may 30 download and install native applications 400a on the user device 300.

The functionality of an application 400 may be accessed on the computing device 300 on which the application 400 is installed. Additionally or alternatively, the functionality of an application 400 may be accessed via a remote computing device 112. In some examples, all of an application's functionality is included on the computing device 112, 300 on which the application 400 is installed. These applications 400 may function without communication with other computing devices 112, 310 (e.g., via the shared network 20, e.g., Internet). In other examples, an application 400 installed on a user device 300 may access information from other remote devices 300 during operation. In still other examples, a web-based application 400b (also referred to herein as a web application) may be partially executed by the user device 300 and partially executed by a remote computing device 112. For example, a web application 400b may be an application 400 that is executed, at least in part, by a web server and accessed by a web browser (e.g., a native application 400a) of the user device 300. Example web applications 400b may include, but are not limited to, web-based email, online auctions, and online retail sites.

In general, the user device 300 may communicate with photo-sharing device 200 using any software application 400 that can send and receive photos 322 and/or videos 324 and that is capable of interfacing with the photo-sharing device 200, such as a native application 400a dedicated to sharing and editing photos.

In some examples, the user device 300 communicates with the photo-sharing device 200 using a more general application 400, such as a web-browser application 400b accessed using a web browser native application 400a. Although the user device 300 may communicate with the photo-sharing device 200 using the native photo-sharing application 400a and/or a web-browser application 400b, the user device 300 may be described hereinafter as using the native photo-sharing application 400 to communicate with the photo-sharing device 200. In some implementations, the functionality attributed to the photo-sharing application 400 may be included as a photo-sharing component of a larger application 400 that has additional functionality. For example, the functionality attributed to the photo-sharing application 400 may be included as part of a native application 400a or a web application 400b as a feature that provides photo-sharing features and capabilities.

Native applications 400a can perform a variety of different functions for a user 30. For example, a restaurant reservation application can make reservations for restaurants. As another example, an internet media player application can stream media (e.g., a song or movie) from the Internet. In some examples, a single native application 400a can perform more than one function. For example, a restaurant reservation application may also allow a user to retrieve information about a restaurant and read user reviews for the restaurant in addition to making reservations. As another example, an internet media player application may also allow a user to perform searches for digital media, purchase digital media, and generate media playlists.

Referring to FIG. 4, in some implementation, the photo-sharing application 400 retrieves device information 410 from the user device 300 and transmits the device information 410 to the photo-sharing device 200. Some application modules of the photo-sharing application 400 used to capture the device information 410 may include, but are not limited to, a geolocation service module 420 that acquires a user device location 422 (e.g., from a geolocation device of the user device 300), a user display module 444 that acquires user actions 446 performed by the user 30 on a user device display 302 or a remote display 332 (e.g., to manipulate a photo) and/or display settings 447. The device information 410 may also include a user device profile 448 (that includes settings such as, but not limited to, device memory management 450), one or more photos folder 452 having photo content 322 to be uploaded to the photo-sharing device 200, one or more videos folder 454 having video content 324 to be uploaded to the photo-sharing device 200, and optionally a device trash folder 458 having photo and/or video content 322, 324 for deletion by the photo-sharing device 200 (e.g., from the user device memory 320 and/or the memory 220 of the photo-sharing device 200).

In some implementations, the photo-sharing application 400 communicates with the photo-sharing device 200 via the home network 10 or the shared network 20 and sends the photo-sharing device 200 the device location 422. In some examples, based on the device location 422, the photo-sharing device 200 initiates retrieval of photos 322 and/or videos 324 from the user device storage 320. The user 30 of the device 300 that executes the photo-sharing application 400 may select which folders 456 stored on the device storage 320 may be accessed by the photo-sharing device 200 so that the photo-sharing device uploads the photos 322 and/or videos 324 in the specified folder to the photo-sharing device 200 (e.g., non-transitory memory 220). Moreover, when a user 30 captures a photo 322 and/or a video 324, the photo-sharing application 400 associates a current device location 422 with the photo 322 and/or a video 324.

In some implementations, the photo-sharing system 100 may be a system of one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the photo-sharing system 200 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the photo-sharing system 100 may be configured to communicate with the network 10, 20. The one or more computing devices of the photo-sharing system 100 may also be configured to communicate with one another (e.g., via a shared network 20). The one or more computing devices may reside within a single machine at a single geographic location in some examples. In other examples, the one or more computing devices may reside within multiple machines at a single geographic location. In still other examples, the one or more computing devices of the photo-sharing system 100 may be distributed across a number of geographic locations.

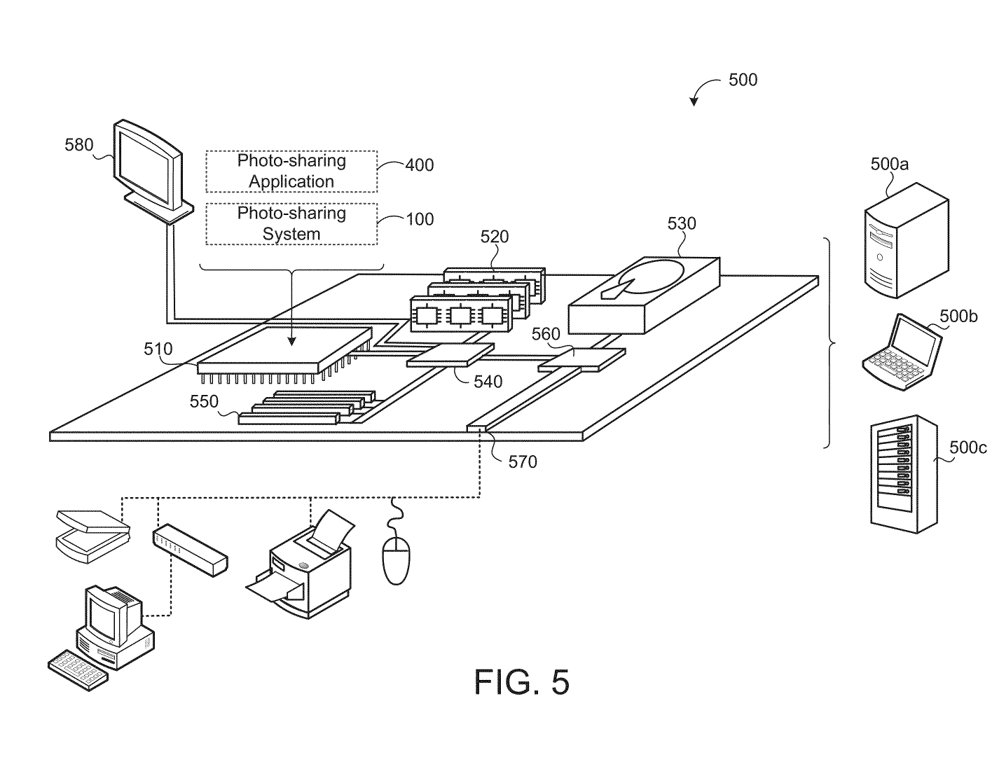

FIG. 5 is schematic view of an example computing device 500 that may be used to implement the systems 100 and methods 600 described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to low speed bus 570 and storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 550. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

As previously described, the memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and low-speed expansion port 570. The low-speed expansion port 570, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

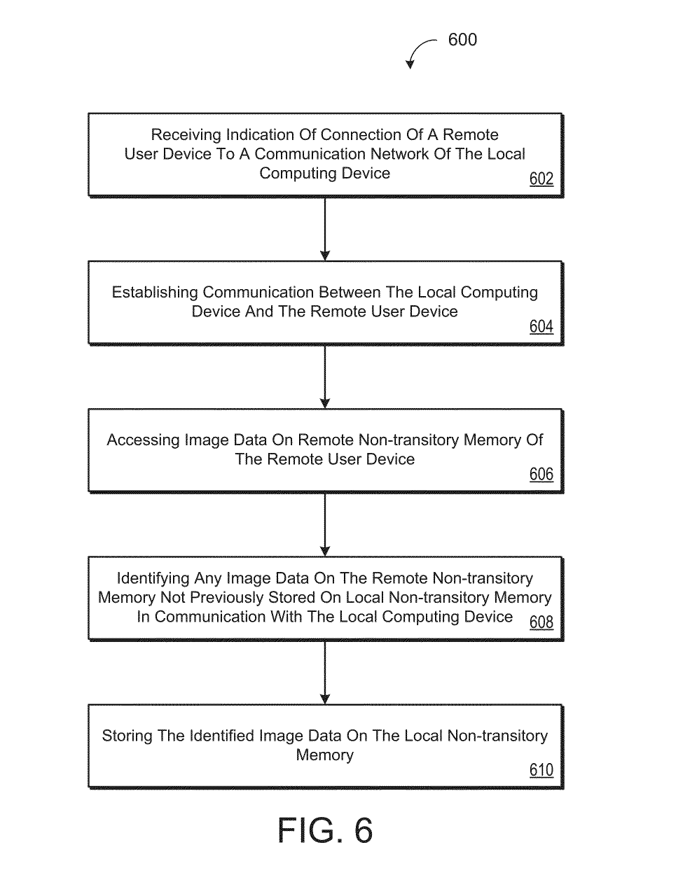

Referring to FIG. 6, in some implementations a method 600 of sharing photos 322 and/or videos 324 includes, at block 602, receiving, at a local computing device (e.g., processor 210 of a photo-sharing device 200), an indication of a connection of a remote user device 300 (e.g., computer, portable electronic device, smartphone, tablet PC, cellular telephone, portable digital assistant, digital camera, digital video camera) to a communication network (e.g., home network 10 or a shared network 20) of the local computing device 210. At block 604, the method 600 includes establishing communication between the local computing device 210 and the remote user device 300; and at block 606, the method 600 includes accessing, using the local computing device 210, image data (e.g., photos 322 and/or videos 324) on remote non-transitory memory 320 of the remote user device 300. The method 600 also includes, at block 608, identifying, using the local computing device 210 (e.g., processor 210), any image data 322, 324 on the remote non-transitory memory 320 not previously stored on local non-transitory memory 220 in communication with the local computing device 210 and storing, at block 610, the identified image data 322, 324 on the local non-transitory memory 220.

In some examples, the method 600 further includes determining, using the local computing device 210, an available storage capacity 328 of the remote non-transitory memory 320. When the available storage capacity 328 is less than a threshold available storage capacity, the method 600 includes identifying image data 322, 324 on the remote non-transitory memory 320 currently stored on the local non-transitory memory 220 and deleting at least some of the image data 322, 324 on the remote non-transitory memory 320 currently stored on the local non-transitory memory 220 to provide at least the threshold available storage capacity on the local non-transitory memory 220. The method 600 may further include identifying for deletion from the remote non-transitory memory 320, using the local computing device 210, infrequently accessed image data 322, 324 currently stored on the local non-transitory memory 220. Additionally or alternatively, the method may include identifying for deletion from the remote non-transitory memory 320, using the local computing device 210, image data 322, 324 currently stored on the local non-transitory memory 220 and having image metadata matching metadata criteria. Therefore, the local computing device 210 monitors the storage capacity 328 of the remote non-transitory memory 320, and deletes (e.g., based on a user setting) a specific number of image data 322, 324 or image data 322, 324 having specific criteria.

In some implementation, the method 600 further includes, using the local computing device 210, identifying whether a user profile 222 is associated with the user device 300. When a user profile 222 is associated with the user device 300, the method 600 also includes storing the identified image data 322, 324 on the local non-transitory memory 220 according to storage criteria (e.g., settings 226, user device profile 448 including memory management settings 450) of the user profile 222. The storage criteria (e.g., settings 226, user device profile 448 including memory management settings 450) may disallow storage of identified image data 322, 324 on the local non-transitory memory 220 when the identified image data 322, 324 has associated image metadata matching disallow criteria of the storage criteria. For example, the disallowed criteria may include a threshold period of time, or any other criteria. Additionally or alternatively, the storage criteria may allow storage of identified image data 322, 324 on the local non-transitory memory 220 when the identified image data 322, 324 has associated image metadata matching allow criteria of the storage criteria.

In some implementations, the method 600 further includes storing, using the local computing device 210, the identified image data 322, 324 on the local non-transitory memory 220 according to default storage criteria when a user device profile 222 is not associated with the user device 300 (e.g., guest device profile 224). The method 600 may further include displaying, using the local computing device 210, image data 322, 324 stored on the local non-transitory memory 220 on a display screen 332 (e.g., a television screen) in communication with the local computing device 210 (e.g., wirelessly via the home network 10 or the shared network 20, or via a cable 50). In some examples, the method 600 also includes receiving, at the local computing device 210 a gesture command, the gesture command received on a touch screen 302 of the user device 300 and indicating whether to display selected image data stored on the local non-transitory memory 220 on the display screen 332.

The method 600 may further include receiving, at the local computing device 210, an image data manipulation from the remote user device 300 for the identified image data 322, 324. In some examples, the image data manipulation includes at least one of an image crop, an image rotation, an image alteration, or an image resize. In some examples, the method 600 also includes receiving, at the local computing device 210, an image metadata manipulation from the remote user device for the identified image data 322, 324.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a local computing device, an indication of connection of a remote user device to a communication network of the local computing device;
establishing communication between the local computing device and the remote user device;
accessing, using the local computing device, image data on remote non-transitory memory of the remote user device;
identifying, using the local computing device, any image data on the remote non-transitory memory not previously stored on local non-transitory memory in communication with the local computing device; and
storing the identified image data on the local non-transitory memory.

2. The method of claim 1, wherein the image data comprises photo image data and/or video image data.

3. The method of claim 1, further comprising:
determining, using the local computing device, an available storage capacity of the remote non-transitory memory; and
when the available storage capacity is less than a threshold available storage capacity:
identifying image data on the remote non-transitory memory currently stored on the local non-transitory memory; and
deleting at least some of the image data on the remote non-transitory memory currently stored on the local non-transitory memory to provide at least the threshold available storage capacity on the remote non-transitory memory.

4. The method of claim 3, further comprising identifying for deletion from the remote non-transitory memory, using the local computing device, infrequently accessed image data currently stored on the local non-transitory memory.

5. The method of claim 3, further comprising identifying for deletion from the remote non-transitory memory, using the local computing device, image data currently stored on the local non-transitory memory and having image metadata matching metadata criteria.

6. The method of claim 1, further comprising, using the local computing device:
identifying whether a user profile is associated with the user device; and
when a user profile is associated with the user device, storing the identified image data on the local non-transitory memory according to storage criteria of the user profile.

7. The method of claim 6, wherein the storage criteria disallows storage of identified image data on the local non-transitory memory when the identified image data has associated image metadata matching disallow criteria of the storage criteria.

8. The method of claim 6, wherein the storage criteria allows storage of identified image data on the local non-transitory memory when the identified image data has associated image metadata matching allow criteria of the storage criteria.

9. The method of claim 1, further comprising storing, using the local computing device, the identified image data on the local non-transitory memory according to default storage criteria when a user profile is not associated with the user device.

10. The method of claim 1, further comprising displaying, using the local computing device, image data stored on the local non-transitory memory on a display screen in communication with the local computing device.

11. The method of claim 10, further comprising receiving, at the local computing device, a gesture command, the gesture command received on a touch screen of the user device and indicating whether to display selected image data stored on the local non-transitory memory on the display screen.

12. The method of claim 1, further comprising receiving, at the local computing device, an image data manipulation from the remote user device for the identified image data.

13. The method of claim 12, wherein the image data manipulation comprises at least one of an image crop, an image rotation, an image alteration, or an image resize.

14. The method of claim 1, further comprising receiving, at the local computing device, an image metadata manipulation from the remote user device for the identified image data.

15. A storage device comprising:
a body;
a local computing device housed by the body; and
local non-transitory memory in communication with the computing device and housed by the body, the local non-transitory memory storing instructions that when executed by the local computing device cause the local computing device to perform operations comprising:
receiving, at the local computing device, an indication of connection of a remote user device to a communication network of the local computing device;
establishing communication between the local computing device and the remote user device;
accessing, using the local computing device, image data on remote non-transitory memory of the remote user device;
identifying, using the local computing device, any image data on the remote non-transitory memory not previously stored on local non-transitory memory in communication with the local computing device; and
storing the identified image data on the local non-transitory memory.

16. The storage device of claim 15, wherein the operations further comprise:
determining, using the local computing device, an available storage capacity of the remote non-transitory memory; and
when the available storage capacity is less than a threshold available storage capacity:
identifying image data on the remote non-transitory memory currently stored on the local non-transitory memory; and
deleting at least some of the image data on the remote non-transitory memory currently stored on the local non-transitory memory to provide at least the threshold available storage capacity on the remote non-transitory memory.

17. The storage device of claim 16, wherein the operations further comprise identifying for deletion from the remote non-transitory memory, using the local computing device, infrequently accessed image data currently stored on the local non-transitory memory.

18. The storage device of claim 16, wherein the operations further comprise identifying for deletion from the remote non-transitory memory, using the local computing device, image data currently stored on the local non-transitory memory and having image metadata matching metadata criteria.

19. The storage device of claim 15, wherein the operations further comprise, using the local computing device:
identifying whether a user profile is associated with the user device; and
when a user profile is associated with the user device, storing the identified image data on the local non-transitory memory according to storage criteria of the user profile.

20. The storage device of claim 19, wherein the storage criteria disallows storage of identified image data on the local non-transitory memory when the identified image data has associated image metadata matching disallow criteria of the storage criteria.

21. The storage device of claim 19, wherein the storage criteria allows storage of identified image data on the local non-transitory memory when the identified image data has associated image metadata matching allow criteria of the storage criteria.

22. The storage device of claim 15, wherein the operations further comprise storing, using the local computing device, the identified image data on the local non-transitory memory according to default storage criteria when a user profile is not associated with the user device.

23. The storage device of claim 15, wherein the operations further comprise displaying, using the local computing device, image data stored on the local non-transitory memory on a display screen in communication with the local computing device.

24. The storage device of claim 23, wherein the operations further comprise receiving, at the local computing device, a gesture command, the gesture command received on a touch screen of the user device and indicating whether to display selected image data stored on the local non-transitory memory on the display screen.

25. The storage device of claim 15, further comprising receiving, at the local computing device, an image data manipulation from the remote user device for the identified image data.

26. The storage device of claim 25, wherein the image data manipulation comprises at least one of an image crop, an image rotation, an image alteration, or an image resize.

27. The storage device of claim 15, further comprising receiving, at the local computing device, an image metadata manipulation from the remote user device for the identified image data.

28. The storage device of claim 15, wherein the image data comprises photo image data and/or video image data.

29. The storage device of claim 15, further comprising a media card receiver supported by the body and in communication with the computing device.

30. The storage device of claim 15, further comprising a visual indicator supported by the body and in communication with the computing device, the visual indicator indicating storage of the identified image data on the local non-transitory memory.

31. The storage device of claim 15, further comprising an audio device supported by the body and in communication with the computing device, the audio device emitting a human perceptible sound indicating storage of the identified image data on the local non-transitory memory.

32. The storage device of claim 15, further comprising a media electrical connector supported by the body and in communication with the computing device.

33. The storage device of claim 15, further comprising a wireless transceiver supported by the body and in communication with the computing device.
